(19) United States
(12) Patent Application Publication
(10) Pub. No.: US 2025/0091308 A1
(43) Pub. Date: Mar. 20, 2025

(54) ACTIVE LAST FOR FORMING AN ARTICLE OF FOOTWEAR

(71) Applicant: NIKE, Inc., Beaverton, OR (US)

(72) Inventor: George A. Xanthos, Beaverton, OR (US)

(73) Assignee: NIKE, Inc., Beaverton, OR (US)

(21) Appl. No.: 18/888,387

(22) Filed: Sep. 18, 2024

Related U.S. Application Data
(60) Provisional application No. 63/584,047, filed on Sep. 20, 2023.

(51) Int. Cl. B29D 35/00; B29D 35/12

(52) U.S. Cl. CPC B29D 35/0018; B29D 35/122; B29D 35/126

(57) ABSTRACT

A method of forming an article of footwear can include flowing a material into an inlet port of a last and through a plurality of interconnected channels extending through an interior of the last that are fluidly connected to the inlet port. The method can further include flowing the material from each channel, out a respective outlet port of the channel that is disposed on an outer surface of the last, and directly onto the outer surface of the last. The method can further include solidifying the material on the outer surface of the last to form at least a portion of the article of footwear.

### CROSS-REFERENCE TO RELATED APPLICATIONS

This application claims the benefit of U.S. Provisional Patent Application No. 63/584,047, filed Sep. 20, 2023, which is incorporated by reference herein in its entirety.

### FIELD

This disclosure relates generally to articles of footwear and, in particular to systems and methods for actively forming at least a portion of an article of footwear, such as an upper, with a last.

### BACKGROUND

An article of footwear typically includes two main components: a sole structure and an upper. The sole structure is configured for supporting the wearer's foot and providing cushioning between the wearer's foot and the ground. The sole structure may include an outsole that is adapted to contact the ground. The upper is coupled to the sole structure and is configured for securing the wearer's foot to the sole structure. During manufacturing, the article of footwear is typically formed around a foot-shaped form called a last.

### BRIEF DESCRIPTION OF THE DRAWINGS

FIG. 1A is a perspective view of an active last for forming at least a portion of an article of footwear.

FIG. 1B is a perspective view of the active last of FIG. 1A which depicts material being emitted onto an outer surface of the last from internal channels of the last.

FIG. 1C is a perspective view of the active last of FIG. 1A which depicts additional material being emitted onto the outer surface of the last from internal channels of the last.

FIG. 2 is a perspective view of an active last comprising a network of internal channels that are fluidly coupled to a pump.

FIG. 3 is a perspective view of the active last of FIG. 2 with repulsive features disposed on the outer surface of the last and a material being emitted from outlet ports of the internal channels onto the outer surface of the last.

FIG. 4 is a perspective view of the active last of FIG. 2 which depicts material emitted from the channels disposed across the outer surface, except for the regions with the repulsive features.

FIG. 5 is a perspective view of the article of footwear or portion of the article of footwear formed with the active last of FIG. 2, removed from the last.

FIG. 6 is a flow chart of a method for forming an article of footwear, or a portion of an article of footwear, onto and with an active last.

FIG. 7A is a perspective view of an active last comprising a plurality of networks of internal channels for depositing multiple materials onto the outer surface of the last.

FIG. 7B is a perspective view of an upper or article of footwear formed with the active last of FIG. 7A.

FIG. 8A is a perspective view of an active last comprising a plurality of internal channels and flow-directing surface features.

FIGS. 8B-8C are perspective views of the active last of FIG. 8A showing material emitted by the channels being directed linearly along the outer surface of the last by the flow-directing surface features.

FIG. 9 illustrates an exemplary computing system for implementing a portion of the disclosed methods.

### DETAILED DESCRIPTION

### General Considerations

The systems and methods described herein, and individual components thereof, should not be construed as being limited to the particular uses or systems described herein in any way. Instead, this disclosure is directed toward all novel and non-obvious features and aspects of the various disclosed examples, alone and in various combinations and subcombinations with one another. For example, any features or aspects of the disclosed examples can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” or “secured” encompasses mechanical and chemical couplings, as well as other practical ways of coupling or linking items together, and does not exclude the presence of intermediate elements between the coupled items unless otherwise indicated, such as by referring to elements, or surfaces thereof, being “directly” coupled or secured. Furthermore, as used herein, the term “and/or” means any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

For purposes of this disclosure, portions of an article of footwear (and the various component parts thereof) may be identified based on regions of the foot located at or near that portion of the article of footwear when the footwear is worn on the properly sized foot. For example, an article of footwear and/or a sole structure may be considered as having a “forefoot region” at the front of the foot, a “midfoot” region at the middle or arch area of the foot, and a “heel region” at the rear of the foot. Footwear and/or sole structures also include a “lateral side” (the “outside” or “little toe side” of the foot) and a “medial side” (the “inside” or “big toe side” of the foot). The forefoot region generally includes portions of the footwear corresponding to the toes and the joints connecting the metatarsals with the phalanges. The midfoot region generally includes portions of the footwear corresponding with the arch area of the foot. The heel region generally corresponds with the rear portions of the foot, including the calcaneus bone. The lateral and medial sides of the footwear extend through the forefoot, midfoot, and heel regions and generally correspond with opposite sides of the footwear (and may be considered as being separated by a central longitudinal axis). These regions and sides are not intended to demarcate precise areas of footwear. Rather, the terms “forefoot region,” “midfoot region,” “heel region,” “lateral side,” and “medial side” are intended to represent general areas of an article of footwear and the various components thereof to aid the in discussion that follows.

For purposes of this disclosure, directional adjectives may be employed which correspond to the illustrated example. For example, the term “longitudinal” as used herein refers to a direction extending a length of an article. In some cases, the longitudinal direction may extend from a forefoot portion to a heel portion of the article. Also, the term “lateral” as used herein refers to a direction extending a width of an article. In other words, the lateral direction may extend between a medial side and a lateral side of an article. Furthermore, the term “vertical” as used herein refers to a direction generally perpendicular to a lateral and longitudinal direction. For example, in cases where an article is planted flat on a ground surface, the vertical direction may extend from the ground surface upward. It will be understood that each of these directional adjectives may be applied to individual components of an article, such as an upper and/or a sole structure.

As used herein, the term “exemplary” means serving as a non-limiting example, instance, or illustration. As used herein, the terms “e.g.,” and “for example,” introduce a list of one or more non-limiting examples, instances, and/or illustrations.

As used herein, the term “sole structure” refers to any combination of materials that provides support for a wearer's foot and bears the surface that is in direct contact with the ground or playing surface, such as, for example, a single sole; a combination of an outsole and an inner sole; a combination of an outsole, a midsole, and an inner sole; and a combination of an outer covering, an outsole, a midsole and an inner sole.

As used herein, the terms “attached” and “coupled” generally mean physically connected or linked, which includes items that are directly attached/coupled and items that are attached/coupled with intermediate elements between the attached/coupled items, unless specifically stated to the contrary.

As used herein, the terms “articles of footwear” or “articles” mean any type of footwear, including, for example, basketball shoes, volleyball shoes, tennis shoes, running shoes, soccer shoes, football shoes, rugby shoes, baseball shoes, sneakers, hiking boots, sandals, socks, etc.

Although the figures may illustrate an article of footwear intended for use on only one foot (e.g., a right foot) of a wearer, one skilled in the art and having the benefit of this disclosure will recognize that a corresponding article of footwear for the other foot (e.g., a left foot) would be a mirror image of the right article of footwear.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, claims, abstract, and drawings.

### The Disclosed Technology

An article of footwear typically includes two main components: a sole structure and an upper. The sole structure is configured for supporting the wearer's foot and providing cushioning between the wearer's foot and the ground (e.g., the surface on which they are moving, walking, running, etc.). The upper is coupled to the sole structure and forms a foot-receiving cavity. The upper is configured for securing the wearer's foot to the sole structure and/or can protect the wearer's foot.

An article of footwear is typically formed around a last. A last is a foot-shaped form that is used in the manufacture of articles of footwear. Lasts can be made of molded plastic, wood, metal (e.g., aluminum), 3D printed plastic, or other firm materials that can withstand the shaping of materials for the article of footwear around the last. An upper for an article of footwear is typically shaped and formed around the last. For example, materials for the upper and/or additional portions of the article of footwear can be pressed onto and around the last. After shaping the upper and/or any additional components of the article of footwear around the last, the upper (or the article of footwear) can be removed from the last. In this way, a traditional last is a passive manufacturing tool for shaping and forming an article of footwear.

Disclosed here are active lasts that are used to form all or portions of articles of footwear, such as an upper, a sole structure, or both, for an article of footwear. For example, a last can comprise a network of internal, interconnected channels (similar to arteries, veins, or roots, for example) through which a material can flow from a supply port to an outer surface of the last. For example, the last can comprise an inlet port (such as at an ankle or top portion of the last) that is configured to receive a material (e.g., a liquid material for an upper) therethrough. The inlet port can then connect to a plurality of channels that extend through an interior of the last, where each channel has an outlet port at a different location on the outer surface of the last. Thus, when material is pushed through the inlet port and into the channels, the material flows through the channels and out their respective outlet ports onto the outer surface of the last. The material can flow across and gather directly on a portion of the outer surface of the last. The material can then set and solidify on the last. After setting, the result can be a portion of an article of footwear, such as an upper or sole structure, or an entire article of footwear formed on the last. The resulting upper, sole structure, or article of footwear, can then be removed from the last.

In some examples, the material can be directed to or away from certain areas of the last by surface features and/or coatings. For example, void spaces or perforations (or areas of no material) can be formed by depositing repulsive coatings on small portions of the last, thereby preventing the material expelled from the channels from forming thereon.

The system of channels can allow an entire upper or article of footwear comprising multiple different materials to be formed. For example, the last can comprise two or more networks of channels, where the different networks are fluidly separated from one another. As a result, two or more different materials can be pushed or pumped through the two or more different networks of channels, thereby forming an upper, other portion of an article of footwear, or an entire article of footwear with specified regions of different materials that have different properties.

In this way, a nearly unlimited number of designs for an article of footwear can be created using an active last. Further, in some instances, the lasts described here can be used to form an upper (or another portion of the article of footwear) directly onto the last (without any intervening layers, such as a base layer, disposed between the last and upper). As a result, a manufacturing process for an article of footwear can be made easier and more cost-effective. For example, the active lasts described herein can allow for at least partial automation of the footwear manufacturing process.

In some examples, a method of forming an article of footwear can include flowing a material into an inlet port of a last and through a plurality of interconnected channels extending through an interior of the last that are fluidly connected to the inlet port. The method can further include flowing the material from each channel, out a respective outlet port of the channel that is disposed on an outer surface of the last, and directly onto the outer surface of the last. The method can further include solidifying the material on the outer surface of the last to form at least a portion of the article of footwear.

In some examples, a last for forming an article of footwear can include a plurality of interconnected channels extending through an interior of the last, wherein the plurality of interconnected channels includes a main channel, a plurality of branched channels, and a plurality of outlet ports spaced apart across an outer surface of the last. Each branched channel of the plurality of branched channels extends from a different location on the main channel to a respective outlet port of the plurality of outlet ports.

In some examples, a method of forming an upper of an article of footwear can include flowing a first material into a first inlet port of a last and through a plurality of interconnected first channels extending through an interior of the last to first outlet ports that are spaced apart from one another on an outer surface of the last, and flowing the first material from the first outlet ports directly onto a first portion of the outer surface of the last. The method can further include flowing a second material into a second inlet port of the last and through a plurality of interconnected second channels extending through the interior of the last to second outlet ports that are spaced apart from one another on the outer surface of the last and flowing the second material from the second outlet ports directly onto a second portion of the outer surface of the last. The method can further include solidifying the first and second materials on the outer surface of the last to form at least a portion of the article of footwear.

Additional examples of the disclosed technology are described below with reference to the accompanying drawings.

### Examples of the Disclosed Technology

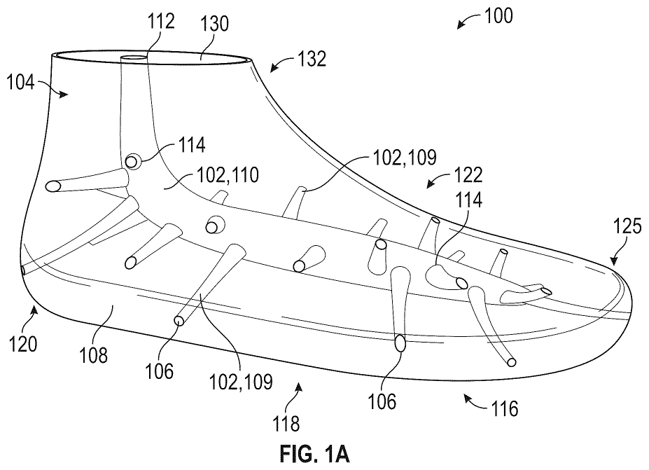

FIGS. 1A-1C show an exemplary active last 100 comprising a network of channels 102 extending through an interior 104 of the last 100 to individual outlet ports 106 spaced apart along the outer surface 108 of the last 100. FIGS. 1A-1C also show a method of depositing a material 126 onto the outer surface 108 using the channels 102, and thereby forming a portion of an article of footwear, such as an upper, on the last 100 (e.g., directly on the last). For example, the method shown in FIGS. 1A-1C can include depositing the material 126 directly onto the outer surface 108 using the channels 102, without any intervening layers of material being disposed over or on the outer surface 108 of the last 100. In this way, an entire upper or article of footwear can be formed with the last 100. For example, while FIGS. 1A-1C may depict the formatting of an entire upper for an article of footwear with the last 100, in other examples the last 100 can be used to form other or additional portions of the article of footwear, such as an upper and sole structure (or outsole) for the article of footwear.

In FIGS. 1A-1C, the last 100 is depicted as being transparent so that the internal channels 102 are visible. However, in some instances, the last 100 can be formed by a translucent or opaque material such that the internal channels 102 are not visible by a user.

Turning to FIG. 1A, the last 100 can comprise a main channel 110 that has an inlet port 112 and a plurality of openings 114 spaced apart along the main channel 110 which connect to (or are continuous with) a plurality of branched channels 109. In some examples, the main channel 110 can be referred to as an internal channel that does not have an outlet on the outer surface of the last 100. In some examples, the main channel 110 can be referred to as a central channel that extends from the inlet port 112 in a top portion 130 (or surface) or ankle region 132 of the last 100 towards a toe region 125 of the last 100. This configuration may allow the branched channels 109 to reach the entire outer surface 108 of the last 100.

Each channel 109 can couple directly to the main channel 110 at a respective opening 114 and then extend through a portion of the interior 104 of the last 100 to a respective outlet port 106 on the outer surface 108 of the last 100. The channels 109 can be spaced apart within the interior 104 and extend from the main channel 110 at different angles such that the outlet ports 106 are spaced apart across the outer surface 108 of the last 100. In this way, different portions of the last 100, such as a forefoot region 116, a midfoot region 118, a heel region 120, a lacing region 122, a toe region 125, and/or the like, can be reach by a material being expelled out of the outlet ports 106.

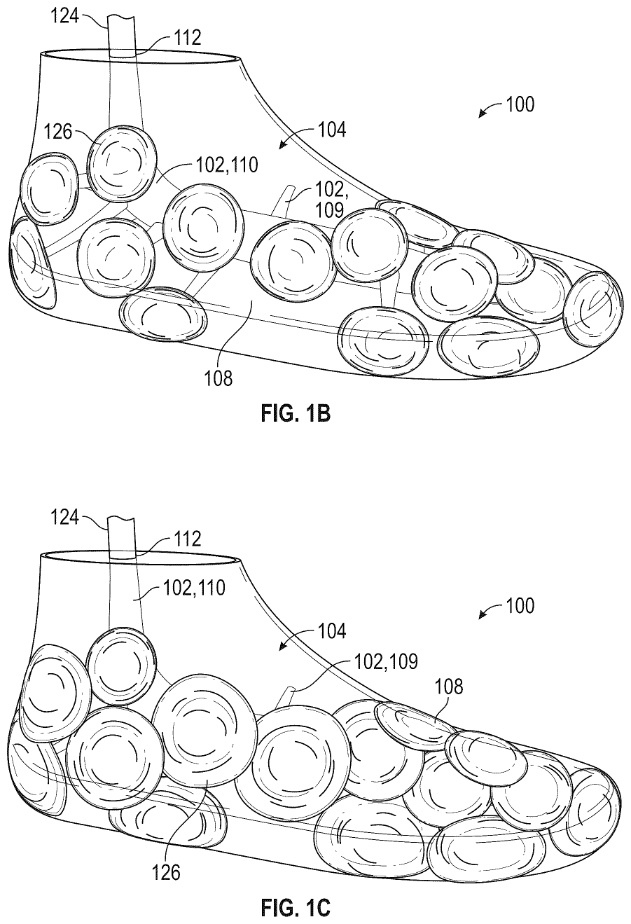

In some examples, as shown in FIGS. 1B and 1C, an inlet tube 124 can be coupled to or extend from the inlet port 112 and extend out of the last 100. The inlet tube 124 can be fluidly coupled to a material supply comprising the target material to be deposited on the upper using the channels 102. In some examples, as described further below with reference to FIG. 2, the inlet tube 124 can be coupled to a syringe or pump that is configured to pump material for forming the article of footwear (or upper) into and through the main channel 110 and branched channels 109.

As shown in FIG. 1, a width or diameter of the main channel 110 is larger than a width or diameter of the branched channels 109. In some examples, all the channels 109 can have a same width or diameter. In some examples, the channels 109 can have different widths or diameters (e.g., at least one channel 109 can have a diameter that is smaller or larger than another channel 109). In some examples, each channel 109 can have a constant width or diameter along its length (from the respective opening 114 to the respective outlet port 106). In some examples, the width or diameter of a channel 109 can vary along its length (e.g., such as having a larger opening 114 than the outlet port 106).

In some examples, the width or diameter of the branched channels 109 can be specified based on the material to be flowed through the branched channels 109 onto the last 100. For example, larger diameter branched channels 109 can be used for use with higher viscosity materials and smaller diameter branched channels 109 can be used for use with lower viscosity materials.

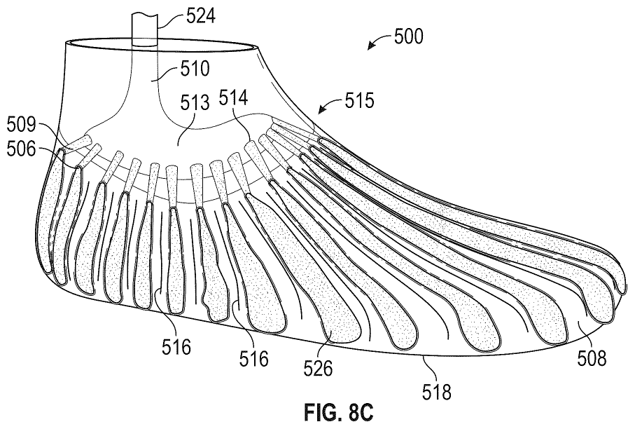

As shown in FIGS. 1B and 1A, when material 126 starts flowing through the main channel 110, the material 126 flows through the main channel 110 and through the branched channels 109 to each of their outlet ports 106. The material 126 is then expelled out from the outlet ports 106 and is pushed onto a portion of the outer surface 108 where the material 126 coalesces (as shown in FIGS. 1B and 1C). In some examples, as shown in FIGS. 1B and 1C, the material 126 can flow out each outlet port 106 and across the outer surface 108 in a circular pattern. However, in other examples, the material can be directed across the outer surface 108 in alternate patterns (such as linear, funneled, or the like) by flow-directing surface features on or of the outer surface 108. An example of such surface features is shown in FIGS. 8A-8C, as described in further detail below.

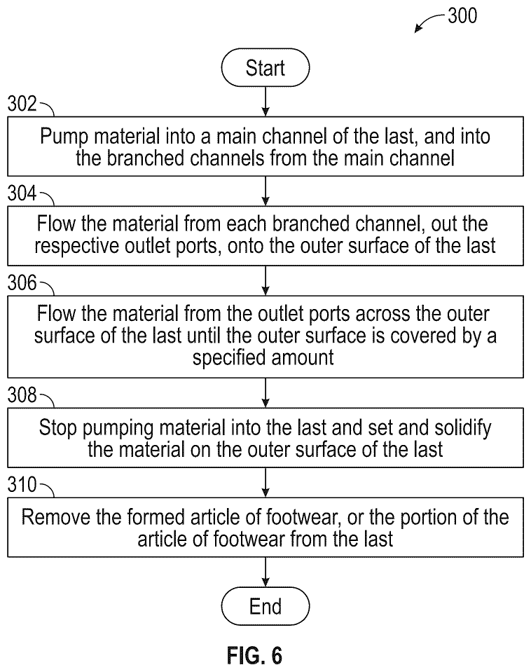

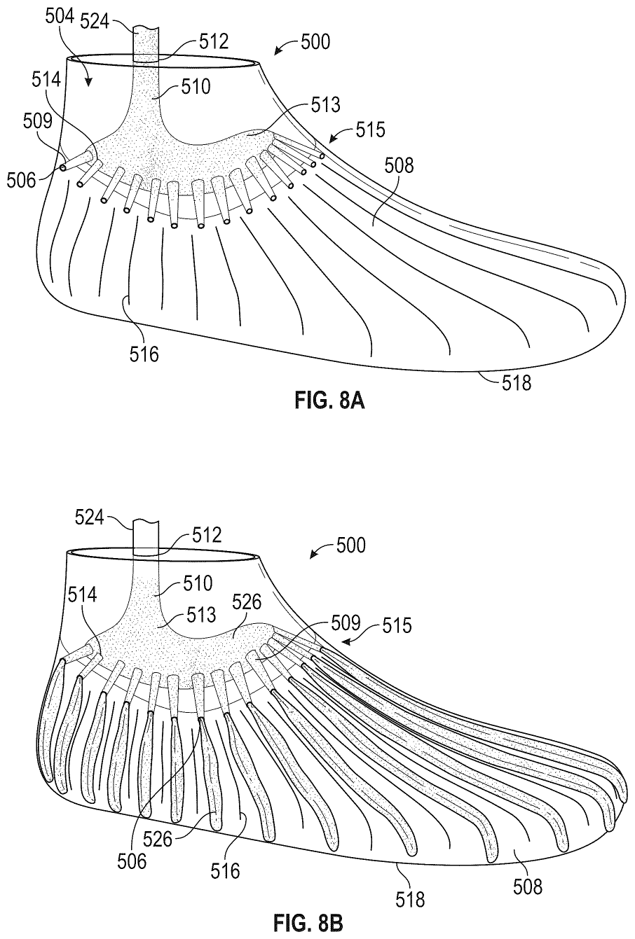

After the material 126 stops flowing through the channels 102, it sets and solidifies into a formed article of footwear or a portion of an article of footwear, such as an upper (e.g., a fabric or polymeric upper or article of footwear comprising the solidified material 126). Exemplary fully formed articles of footwear or portions of an article of footwear (e.g., an upper) are shown in FIGS. 5 and 7B, as described in further detail below.

In some examples, an upper formed by the last 100 can be a complete or entire upper that is then removed from the last and coupled with a sole structure to form a complete article of footwear.

As introduced above, in some examples, a pump 230 can be coupled to the last for pumping material into the channels. For example, FIG. 2 shows an exemplary last 200 with an inlet tube 224 coupled to the pump 230. The last 200 can be similar to the last 100. For example, the last 200 comprises a main channel 210 with an inlet port 212 coupled to the inlet tube 224 and a plurality of channels 209 branching off from the main channel 210. Each channel 209 extends from a different location on the main channel 210 (at an opening 214) to an outlet port 206 on the outer surface 208 of the last 200.

The pump 230 can be manual (e.g., a syringe) or an active pump (e.g., an electrical pump). In some examples, settings of the pump 230 (e.g., flow rate) can be changed based on the material being flown through the channels 209, 210.

The pump 230 can comprise an internal power supply (e.g., battery), or be electrically coupled to a power supply 232 (as shown schematically in FIG. 2).

In some examples, the last 200 can comprise a vibration motor 234. The vibration motor 234 can be activated to emit vibrations at a certain frequency. The vibrations from the vibration motor 234 can create patters on the last 200 as the material 226 is emitted and solidifying on the last 200. A frequency of the vibration can be specified based on the material 226, a desired pattern for the material 226 on the outer surface 208 of the last 200, and/or the like.

Although the vibration motor 234 is shown coupled to a side of the last 200, in some examples, the vibration motor may be positioned on another portion of the last 200, such as a bottom or ground-facing surface of the last 200, or positioned off but proximate to the last 200, such as positioned on a surface on which the last 200 sits, such that its vibrations are transferred to the last 200.

In some examples, the last 200 may not include the vibration motor 234.

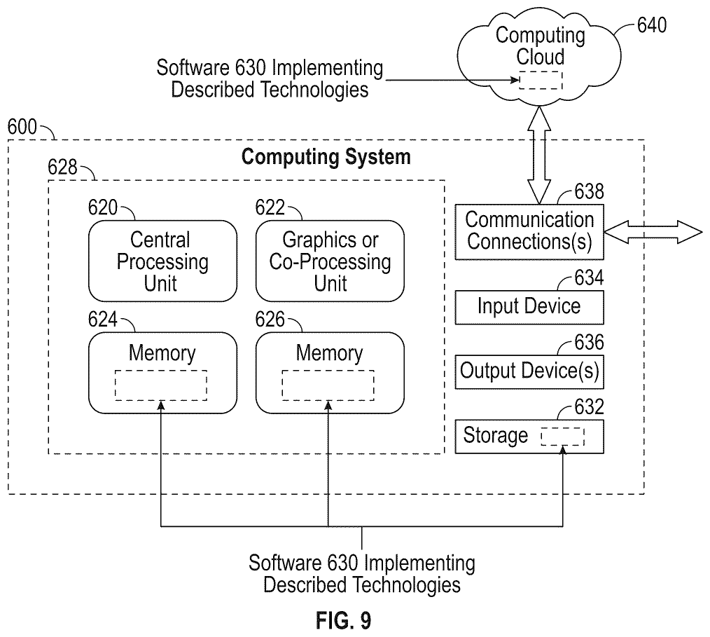

In some examples, a computing system, such as the computing system shown in FIG. 9, as described below, can be used to control the pump 230 and/or the vibration motor 234.

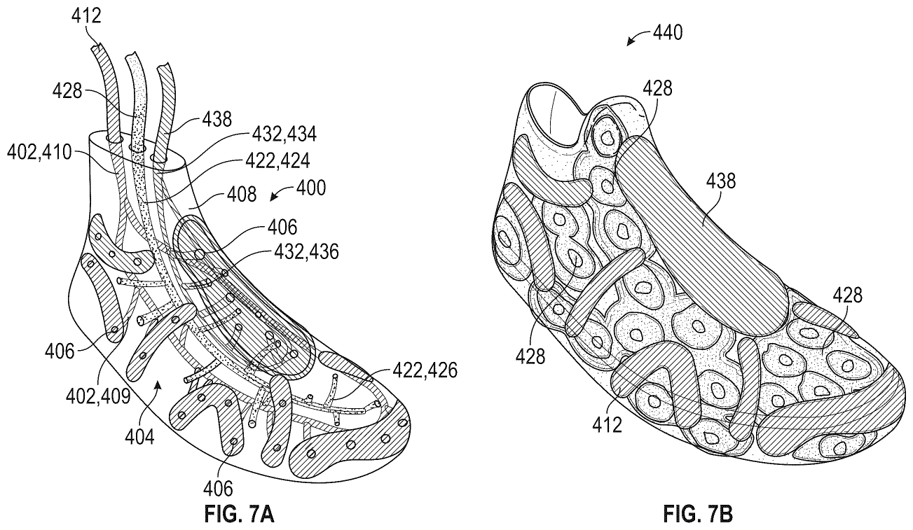

FIG. 6 presents a method 300 for forming an article of footwear, or a portion of an article of footwear (such as an upper) onto and with a last (e.g., an active last). The method 300 can be performed, at least in part, with an active last, such as the last 100 of FIGS. 1A-1C, last 200 of FIGS. 2-4, last 400 of FIG. 7A, or last 500 of FIGS. 8A-8C. In some examples, portions of the method 300 can be further performed using a computing system, such as the exemplary computing system shown in FIG. 9 (as described below).

While the method 300 may be explained below with reference to the examples shown in FIGS. 1A-5 and 7A-8C, it should be noted that the method 300 can be applied to a variety of active lasts for forming an entire article of footwear (e.g., including an upper and a sole structure), or a portion of an article of footwear, such as an upper or a sole structure. In this way, the method 300 can be used to form articles of footwear, uppers, and/or sole structures with various materials, patterns, structural features, and the like.

Further, the method 300 can include forming all or a portion of an article of footwear with the last, and directly on the outer surface of the last. For example, a base layer or additional material may not be first arranged on the outer surface of the last before pumping material through the last and onto the outer surface.

In particular, the method 300 may be explained at least partially below with reference to the example shown in FIGS. 2-5, which depict depositing a material 226 directly onto the outer surface 208 of the last 200 using the channels 209, 210, and thereby forming a portion of an article of footwear, such as an upper, on the last 200 (e.g., directly on the outer surface 208 of the last 200).

Turning to FIG. 6, the method 300 begins at 302 by pumping (or flowing) material into a main channel of the last (e.g., the main channel 210 of last 200) and into the branched channels (e.g., the branched channels 209 from the main channel). In some examples, the method at 302 can include pumping the material into the last at a specified flow rate.

In some examples, the method at 302 can include activating the pump 230 of the last 200 to pump material 226 into the main channel 210, and into the branched channels 209 from the main channel 210 (as shown in FIG. 2). In some examples, the method at 302 can include adjusting the settings of the pump, such as the flow rate, based on the material (e.g., based on the material properties). For example, different flow rates can be used for different materials (e.g., having different viscosities).

In some examples, the method at 302 can include manually pumping material into the last using a syringe or other manual apparatus.

The material flowing or pumped into the last can be a liquefied and/or flowable material that is configured to flow freely through the channels of the last and solidify after being emitted onto the outer surface of the last and sitting or curing thereon for a predetermined time, as explained further below. In some examples, the material can be a material for an upper of an article of footwear. In some examples, the material can be a material for a sole structure (e.g., an outsole) of an article of footwear.

In some examples, the flowable material for injecting via the last can be a latex material.

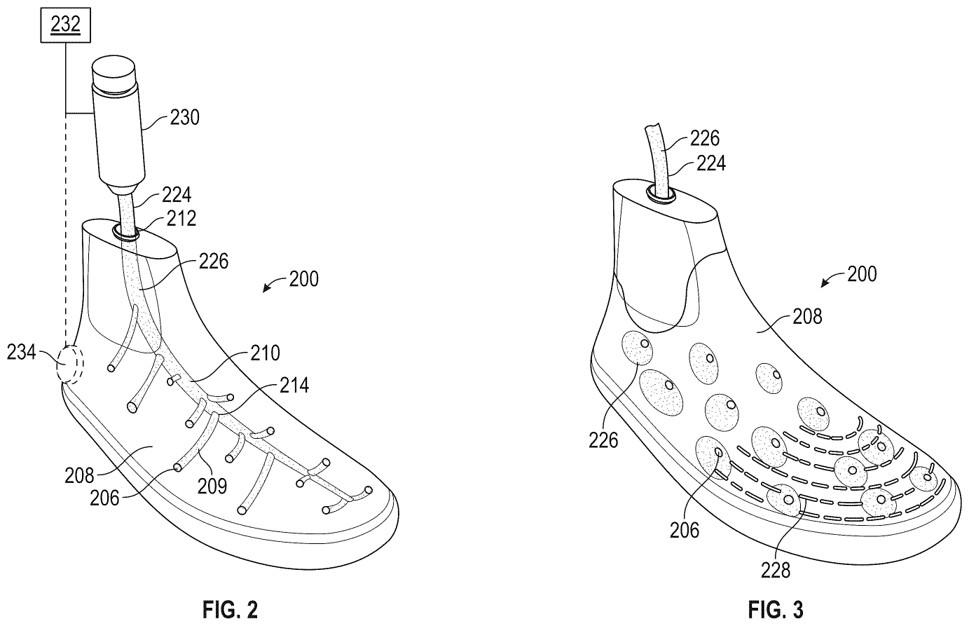

The method at 304 includes flowing the material (e.g., material 226) from each branched channel (e.g., each branched channel 209), out the respective outlet ports (e.g., outlet ports 206 shown in FIG. 2) and onto the outer surface of the last (as shown in FIG. 3, for example). For example, the method at 304 can include flowing the material from the interior of the last out the respective outlet ports and directly onto the outer surface of the last (e.g., the outer surface 208 of the last 200). As a result, the material emitted from the outer ports onto the outer surface can be in direct contact with the outer surface of the last.

In some examples, the method at 304 (and/or at 306) can include actuating a vibration motor of the last or coupled to the last (e.g., vibration motor 234) to emit vibrations at a specified frequency. The vibrations from the vibration motor can create patterns on the last as the material is emitted and solidifying on the last. In some examples, the method can include adjusting the frequency of the vibration of the vibration motor based on the material, a desired pattern for the material on the outer surface of the last, and/or the like.

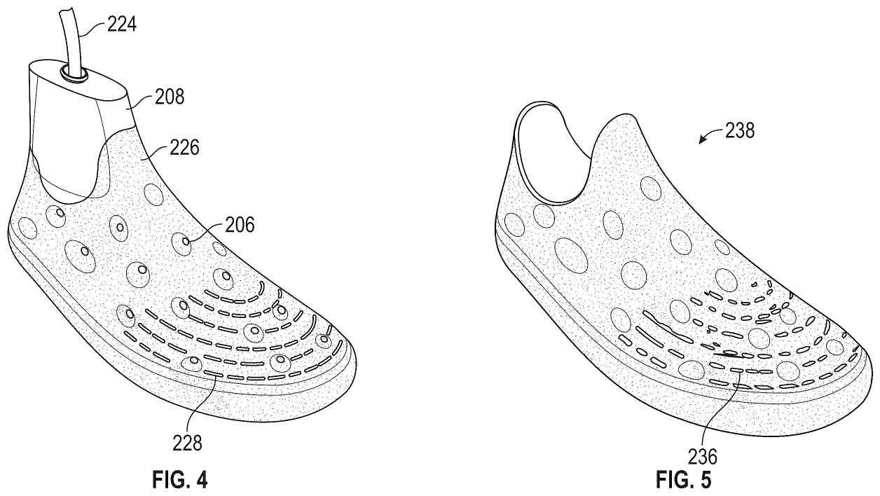

The method at 306 includes flowing the material (e.g., material 226) from the outlet ports across the outer surface of the last until the outer surface is covered by a specified amount. For example, as shown in FIG. 4, the material 226 can continue to flow out the outlet ports 206, across the outer surface 208 until almost an entirety of the outer surface 208 of the last 200 is covered. For example, as shown in FIG. 4, the specified amount may cover an amount of the last 200 that is suitable for forming an upper 238 (e.g., an entire upper) of an article of footwear (as shown in FIG. 5). In other examples, the specified amount may be an amount sufficient to form another portion of an article of footwear, or an entire article of footwear (e.g., the upper 238 and a sole structure).

In some examples, the method at 306 can include continuing to flow the material out the outlet ports and across the outer surface of the last until a specified portion of the outer surface is covered and the material on the specified portion is at a specified thickness.

The method at 308 includes stopping pumping the material into the last and setting and solidifying the material on the outer surface of the last. In some examples, the method at 308 can include stopping the pump 230 to stop the flow of material 226 out the outlet ports 206 (e.g., as shown in FIG. 4). In some examples, the method at 308 can include stopping pumping material into the last. The method at 308 can include allowing the last with the material formed thereon to sit for a predetermined amount of time to allow the material to solidify. In some examples, the method at 308 can include allowing the material on the last to cure through application of one or more external sources, such as light (e.g., UV radiation) and/or heat.

The method 300 continues to 310, where the method includes removing the formed article of footwear, or the portion of the article of footwear from the last. For example, as shown in FIG. 5, the formed upper 238 (an entire upper) can be removed from the last 200.

In some examples, the method 300 can include coating (e.g., spraying, dipping, or other wise applying) at least a portion of the external surface of the last (prior to pumping the material into the last) with a material that allows the finished upper or article of footwear to be more easily separated from the last (e.g., peeled off the last as one unit). For example, the last 200 or any of the other lasts described herein can be coated with a non-stick material that allows the formed article of footwear, or portion of article of footwear, to be removed from the last without adhering to the formed article of footwear or upper. In some embodiments, the non-stick material or coating may not be part of the final, formed upper or article of footwear (e.g., the material can remain on the last when the last is separated from the formed portion of the article of footwear).

In some examples, the last (such as last 200) can be configured as a removable scaffold that allows the formed article of footwear, upper, or other portion of the article of footwear to be easily removed from the last. For example, the last, in some instances, can be a foldable or collapsible scaffold.

After removing the formed article of footwear, or the formed portion of the article of footwear from the last at 310, the method can further include coupling the formed portion of the article of footwear with one or more features to form the final article of footwear. For example, for the upper 238 of FIG. 5, the method can include attaching a sole structure to the upper 238 and/or attaching a lace to a lacing region of the upper 238.

In some examples, the method 300 can be used to form a sole structure alone or a sole structure in combination with an upper. For example, the channels of the last (such as channels 209) can be oriented and/or sized within the last such that a greater amount of material is expelled from the last on a bottom side of the last (e.g., under the foot). For example, the underfoot or bottom region of the last can include larger outlet ports or a greater number of outlet ports to form a sole structure (e.g., a sole structure that is thicker and/or more rigid than the upper of the formed article of footwear). In this way, any of the active lasts described herein and the method 300 can be used to create an entire article of footwear which includes an integrated (e.g., formed as one unitary piece) upper and sole structure.

In some examples, and as described in further detail below, the last can comprise multiple networks of channels and a first network of channels can be configured to emit a first material to form an upper directly onto the last, and a second network of channels can be configured to emit a second material to form a sole structure directly onto (and coupled to or continuous with the upper) the last.

In some examples (e.g., as shown in FIGS. 3-4), one or more repulsive features 228 can be disposed on the outer surface 208 of the last 200. The repulsive features 228 can be configured to repel the emitted material 226, such that none of the material 226 emitted onto the outer surface 208 coalesces and solidifies on the repulsive features 228. In some instances, the repulsive features 228 can be nonstick surface coatings or materials (e.g., wax) deposited onto the last 200 prior to flowing the material 226 through the last 200. In some instances, the repulsive features 228 can be structural features that are directly coupled to or integrated with the outer surface 208 of last and comprise a material that is nonstick or repulsive to the material 226 such that it will not adhere to or form on the structural features.

The repulsive features 228 can be shaped and arranged across the last 200 in order to create desired structural features on the final article of footwear or portion of the article of footwear, such as void spaces or perforations 236 in an upper 238, as shown in FIG. 5.

Thus, in some examples, the method at 304 and 306 of method 300 can include flowing the material 226 out of the outlet ports 206, onto and across the outer surface 208 of the last 200, while avoiding or only flowing up to outermost edges of the repulsive features 228.

Turning now to FIGS. 7A-7B, in some examples, a last 400 can comprise multiple networks of channels 402, 422, 432 (as shown in FIG. 7A) for different materials with different material properties, different colors, and/or the like. For example, a first network of channels 402 can comprise a main channel 410 and branched channels 409 which are configured to receive and flow a first material 412 to specified regions of the outer surface 408 of the last 400. The last 400 can comprise a second network of channels 422 which includes a main channel 424 and branched channels 426 which are configured to receive and flow a second material 428 to specified regions of the outer surface 408 of the last 400. The last 400 can comprise a third network of channels 432 which includes a main channel 434 and branched channels 436 which are configured to receive and flow a third material 438 to specified regions of the outer surface 408 of the last 400. Each branched channel of the networks of channels 402, 422, and 432 includes a respective outlet port 406 (or outlet opening) on the outer surface 408 of the last 400.

The different networks of channels 402, 422, and 432 can be fluidly separated from one another such that the three different materials are kept separate from one another inside the last 400.

In some examples, the method at 302, 304, 306, and/or 308 can include flowing a first material into a first inlet port of a last and through a plurality of interconnected first channels extending through an interior of the last to first outlet ports that are spaced apart from one another on the outer surface of the last, and flowing the first material from the first outlet ports directly onto a first portion of the outer surface of the last. The method 300 can further include flowing a second material into a second inlet port of the last and through a plurality of interconnected second channels extending through the interior of the last to second outlet ports that are spaced apart from one another on the outer surface of the last and flowing the second material from the second outlet ports directly onto a second portion of the outer surface of the last. The method at 308 can include solidifying the first and second materials on the outer surface of the last to form at least a portion of the article of footwear.

In this way, an upper 440 (or another portion or complete article of footwear, such as an upper and a sole structure) can be formed with multiple materials having different properties (such as different durometers, colors, textures, and/or the like) with the same last 400. In this way, various combinations of materials and designs for an article of footwear can be obtained using the same active last.

FIGS. 8A-8C depict an exemplary arrangement of channels within a last 500. The last 500 comprises a network of channels that includes a main channel 510 that has an inlet port 512 and that opens to an elongated channel portion or reservoir 513 with a plurality of openings 514 spaced apart along the reservoir 513. The network of channels further includes a plurality of branched channels 509.

In some examples, an inlet tube 524 can be coupled to the inlet port 512 and extend out of the last 500, similar to the inlet tube 124 (as described above).

Each channel 509 can couple directly to the reservoir 513 of the main channel 510 at a respective opening 514 and then extend through a portion of the interior 504 of the last 500 to a respective outlet port 506 on the outer surface 508 of the last 500. The channels 509 can be spaced apart within the interior 504 and around an upper or ankle region 515 of the last 500 such that the outlet ports 506 are spaced apart around the upper or ankle region 515 of the outer surface 508.

In some examples, the last 500 can comprise one or more, or a plurality of surface features 516 that are configured to direct material flowing out of the outlet ports 506 across the outer surface 508 of the last 500. Thus, the surface features 516 can be referred to herein as flow-directing surface features 516.

For example, as shown in FIGS. 8A-8C, the surface features 516 are spaced apart around the last 500, with each surface feature 516 extending from the ankle region 515 toward a bottom or ground-facing surface 518 of the last 500. Each surface feature 516 can be disposed between two adjacent outlet ports 506. As such, when a material 526 flows through the channels 509 and out the outlet ports 506, the material 526 flows across the outer surface 508 along a pathway defined between two adjacent surface features 516 (as shown in FIG. 8B).

As the material 526 continues to flow out the channels 509, more of the surface 508 becomes covered with the material 526, in the spaces or pathways between the surface features 516 (as shown in FIG. 8C). In some examples, the material 526 can flow across the outer surface 508 up to the edges or boundaries of the surface features 516.

In some examples, the surface features 516 can be slightly raised or protruding portions of the last 500 that extend outward and away from the outer surface 508.

In some examples, the surface features 516 can be lines of a repulsive or non-stick material that prevents the material 526 from adhering thereto.

In this way, the surface features 516 can direct the flow of material 526 across the outer surface 508 in a linear (ankle to ground facing surface) direction or pattern rather than a circular pattern (as in FIGS. 1A-4, for example). Thus, in some examples the method 300 can include (e.g., at 304 and 306), directing the material flowing out each outlet port across the outer surface in a specified pattern via one or more or a plurality of flow-directing surface features of the last.

The resulting upper, portion of the article of footwear, or complete article of footwear can comprise solidified material 526 across the last 500. However, the final appearance of the resulting article of footwear or portion of the article of footwear may be different than that of FIG. 5, for example.

It should be noted that FIGS. 8A-8C present one possible arrangement of last surface features for directing the flow of one or more materials across the outer surface of the last, and other arrangements than that shown in FIGS. 8A-8C is possible. For example, the surface features for directing flow can extend at angles different than shown in FIGS. 8A-8C, in helical patterns, in curved patterns, in zig-zag patterns, and/or the like.

Further, it should be noted that any features of one last described herein can be combined with one or more features of another last described herein. For example, the last 400 including a multiple networks of interconnected channels can also include the flow-directing surface features of the last 500.

In this way, a variety of uppers, sole structures, or articles of footwear with different aesthetics and performance properties can be obtained using an active last and different combinations and arrangements of surface coatings, flow directing surface features, and internal channel arrangements.

As described herein and as shown in the figures, the resulting articles of footwear can comprise solidified material that forms all or part of the article of footwear, including, for example, a portion of an upper, an entirety of an upper, a portion of a sole structure, an entirety of a sole structure, a portion of or the entirety of both an upper and a sole structure.

In some embodiments, the solidified material can comprise a plurality of circular areas and/or a plurality of elongate areas that extend from a throat area of the upper to a lower portion at or adjacent to a sole structure.

In some examples, the resulting articles of footwear can comprise one or more perforations or areas that are void of the solidified material.

In some examples, the resulting articles of footwear can comprise multiple solidified materials having different material properties and/or colors that form all or part of the article of footwear, including, for example, a portion of an upper, an entirety of an upper, a portion of a sole structure, an entirety of a sole structure, a portion of or the entirety of both an upper and a sole structure.

In some examples, the formed upper can comprise a different solidified material than the formed sole structure of the article of footwear.

### Exemplary Control Systems and Computing Systems

FIG. 9 shows an exemplary computing system for implementing a portion of the methods disclosed herein, such as controlling the pump 230, the vibration motor 234, and/or other various inputs to the active lasts described herein.

FIG. 9 depicts a generalized example of a suitable computing system 600 in which the above-described innovations may be implemented. The computing system 600 is not intended to suggest any limitation as to scope of use or functionality, as the innovations may be implemented in diverse general-purpose or special-purpose computing systems. For example, the computing system 600 can be used to implement hardware and software.

With reference to FIG. 9, the computing system 600 includes one or more processing units 620, 622, non-volatile memory 624, and memory 626. In FIG. 9, this basic configuration 628 is included within a dashed line. The processing units 620, 622 execute computer-executable instructions, including instructions for operating a pump and/or vibration motor of an active last, as disclosed herein (e.g., as described above with reference to FIGS. 2 and 6). A processing unit can be a general-purpose central processing unit (“CPU”), processor in an application-specific integrated circuit (“ASIC”), or any other type of processor. In a multi-processing system, multiple processing units execute computer-executable instructions to increase processing power. For example, FIG. 9 shows a central processing unit 620 as well as a graphics processing unit (“GPU”) or co-processing unit 622. The tangible memory 624 may be volatile memory (e.g., registers, cache, RAM), non-volatile memory (e.g., ROM, EEPROM, flash memory, etc.), or some combination of the two, accessible by the processing unit(s). The memory 626 stores software 630 implementing one or more innovations described herein, in the form of computer-executable instructions suitable for execution by the processing unit(s).

A computing system may have additional features. For example, the computing system 600 includes storage 632, one or more input devices 634, one or more output devices 636, and one or more communication connections 638. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 632 may be removable or non-removable, and includes magnetic disks, magnetic tapes or cassettes, CD-ROMs, DVDs, or any other medium which can be used to store information and which can be accessed within the computing system 600. The storage 632 stores instructions for the software 630 for implementing one or more innovations described herein.

The input device(s) 634 may be a touch input device such as a keyboard or other devices that provides input to the computing system 600 (e.g., a mouse or imaging device). For video encoding, the input device(s) 634 may be a camera with an image sensor, video card, TV tuner card, or similar device that accepts video input in analog or digital form, or a CD-ROM, CD-RW, DVD, or Blu-Ray that reads video samples into the computing system 600.

The output device(s) 636 may be any device that receives an output or that is controlled by the computing system 600 by instructions, or a series of instructions, from the computing system 600 (such as a motor or pump of or coupled to the active lasts described herein).

The communication connection(s) 638 enable communication over a communication medium (e.g., a connecting network) to another computing entity. The communication medium conveys information such as computer-executable instructions, compressed graphics information, video, or other data in a modulated data signal. The communication connection(s) 638 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 640. For example, disclosed computer-readable instructions can be executed by processors located in the computing environment or system 600, or the disclosed computer-readable instructions can be executed on servers located in the computing cloud 640.

Computer-readable media are any available media that can be accessed within a computing environment or system, 600. By way of example, and not limitation, with the computing environment 600, computer-readable media include memory 626 and/or storage 632. As should be readily understood, the term computer-readable storage media includes the media for data storage such as memory 626 and storage 632, but does not include transmission media such as modulated data signals or other transitory signals.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular data types. The functionality of the program modules may be combined or split between program modules as desired in various embodiments. Computer-executable instructions for program modules may be executed within a local or distributed computing system.

### Additional Examples of the Disclosed Technology

Additional examples of the disclosed technology are enumerated below.

Example 1. A method of forming an article of footwear, comprising: flowing a material into an inlet port of a last and through a plurality of interconnected channels extending through an interior of the last that are fluidly connected to the inlet port; flowing the material from each channel, out a respective outlet port of the channel that is disposed on an outer surface of the last, and directly onto the outer surface of the last; and solidifying the material on the outer surface of the last to form at least a portion of the article of footwear.

Example 2. The method of any example herein, particularly example 1, wherein the at least the portion of the article of footwear includes an entire upper of the article of footwear.

Example 3. The method of any example herein, particularly example 1, wherein the at least the portion of the article of footwear includes an upper and sole structure of the article of footwear.

Example 4. The method of any example herein, particularly any one of examples 1-3, wherein flowing the material from each channel and directly onto the outer surface of the last includes flowing the material out each outlet port, onto and across the outer surface of the last up to one or more repulsive features on the last and solidifying the material on the outer surface of the last such that the portion of the article of footwear is formed with void spaces in regions of the one or more repulsive features.

Example 5. The method of any example herein, particularly any one of examples 1-4, wherein the flowing the material includes actuating a pump to pump the material into and through the plurality of interconnected channels at a specified flow rate.

Example 6. The method of any example herein, particularly example 5, further comprising adjusting the specified flow rate of the pump based on the material.

Example 7. The method of any example herein, particularly any one of examples 1-6, further comprising actuating a vibration motor coupled to the last to emit vibrations at a specified frequency to create patterns in the material on the last as the material flows onto and is solidified on the outer surface of the last.

Example 8. The method of any example herein, particularly any one of examples 1-7, wherein flowing the material into the inlet port includes: flowing a first material into a first inlet port of the last and through a plurality of interconnected first channels extending through the interior of the last that are fluidly connected to the first inlet port, and flowing the first material from each first channel, out a respective first outlet port of the first channel that is disposed on the outer surface of the last, and directly onto the outer surface of the last; and flowing a second material into a second inlet port of the last and through a plurality of interconnected second channels extending through the interior of the last that are fluidly connected to the second inlet port, and flowing the second material from each second channel, out a respective second outlet port of the second channel that is disposed on the outer surface of the last, and directly onto the outer surface of the last.

Example 9. The method of any example herein, particularly example 8, wherein first outlet ports of the plurality of interconnected first channels are spaced away from second outlet ports of the plurality of interconnected second channels on the outer surface of the last.

Example 10. A last for forming an article of footwear, comprising: a plurality of interconnected channels extending through an interior of the last, wherein the plurality of interconnected channels comprises: a main channel; a plurality of branched channels; and a plurality of outlet ports spaced apart across an outer surface of the last, wherein each branched channel of the plurality of branched channels extends from a different location on the main channel to a respective outlet port of the plurality of outlet ports.

Example 11. The last of any example herein, particularly example 10, wherein the plurality of outlet ports are spaced apart across the outer surface of the last such that at least a portion of outlet ports of the plurality of outlet ports are disposed at each of a forefoot region, midfoot region, and heel region of the last.

Example 12. The last of any example herein, particularly either example 10 or example 11, wherein the main channel extends from an inlet port on a top portion of the last, through the interior of the last, toward a toe region of the last.

Example 13. The last of any example herein, particularly example 10, wherein the plurality of outlet ports are spaced apart across the outer surface of the last such that the plurality of outlet ports extend around an ankle region of the last, and further comprising a plurality of surface features extending from the ankle region toward a ground-facing surface of the last, wherein the plurality of surface features are configured to direct a flow of material emitted from the plurality of outlet ports across the outer surface of the last in a specified pattern.

Example 14. The last of any example herein, particularly any one of examples 10-13, further comprising a pump fluidly coupled to the main channel, wherein the pump is configured to pump material into and through the main channel and the plurality of branched channels such that the material is emitted directly onto and across the outer surface of the last.

Example 15. The last of any example herein, particularly any one of examples 10-14, further comprising a vibration motor coupled to a surface of the last, wherein the vibration motor is configured to emit vibrations at a specified frequency such that patterns of material emitted from the plurality of outlet ports are created on the outer surface of the last.

Example 16. The last of any example herein, particularly any one of examples 10-15, further comprising one or more repulsive features disposed on the outer surface of the last, wherein the one or more repulsive features are configured to repel material emitted from the outlet ports onto the outer surface such that none of the material coalesces and solidifies on the one or more repulsive features.

Example 17. The last of any example herein, particularly example 16, wherein the one or more repulsive features comprise a nonstick material deposited onto the outer surface of the last.

Example 18. The last of any example herein, particularly example 16, wherein the one or more repulsive features are structural features that are directly coupled to or integrated with the outer surface of last and comprise a material that is nonstick or repulsive to the material emitted from the outlet ports.

Example 19. A method of forming an upper of an article of footwear, comprising: flowing a first material into a first inlet port of a last and through a plurality of interconnected first channels extending through an interior of the last to first outlet ports that are spaced apart from one another on an outer surface of the last, and flowing the first material from the first outlet ports directly onto a first portion of the outer surface of the last; flowing a second material into a second inlet port of the last and through a plurality of interconnected second channels extending through the interior of the last to second outlet ports that are spaced apart from one another on the outer surface of the last, and flowing the second material from the second outlet ports directly onto a second portion of the outer surface of the last; and solidifying the first and second materials on the outer surface of the last to form at least a portion of the article of footwear.

Example 20. The method of any example herein, particularly example 19, wherein the at least the portion of the article of footwear includes an entire upper of the article of footwear which comprises the first and second materials.

In view of the many possible examples to which the principles of the disclosed technology may be applied, it should be recognized that the illustrated examples are only preferred examples of the disclosed technology and should not be taken as limiting the scope of the claimed subject matter. Rather, the scope of the claimed subject matter is defined by the following claims and their equivalents.

1. A method of forming an article of footwear, comprising:
flowing a material into an inlet port of a last and through a plurality of interconnected channels extending through an interior of the last that are fluidly connected to the inlet port;
flowing the material from each channel, out a respective outlet port of the channel that is disposed on an outer surface of the last, and directly onto the outer surface of the last; and
solidifying the material on the outer surface of the last to form at least a portion of the article of footwear.

2. The method of claim 1, wherein the at least the portion of the article of footwear includes an entire upper of the article of footwear.

3. The method of claim 1, wherein the at least the portion of the article of footwear includes an upper and sole structure of the article of footwear.

4. The method of claim 1, wherein flowing the material from each channel and directly onto the outer surface of the last includes flowing the material out each outlet port, onto and across the outer surface of the last up to one or more repulsive features on the last and solidifying the material on the outer surface of the last such that the portion of the article of footwear is formed with void spaces in regions of the one or more repulsive features.

5. The method of claim 1, wherein the flowing the material includes actuating a pump to pump the material into and through the plurality of interconnected channels at a specified flow rate.

6. The method of claim 5, further comprising adjusting the specified flow rate of the pump based on the material.

7. The method of claim 1, further comprising actuating a vibration motor coupled to the last to emit vibrations at a specified frequency to create patterns in the material on the last as the material flows onto and is solidified on the outer surface of the last.

8. The method of claim 1, wherein flowing the material into the inlet port includes:
flowing a first material into a first inlet port of the last and through a plurality of interconnected first channels extending through the interior of the last that are fluidly connected to the first inlet port, and flowing the first material from each first channel, out a respective first outlet port of the first channel that is disposed on the outer surface of the last, and directly onto the outer surface of the last; and
flowing a second material into a second inlet port of the last and through a plurality of interconnected second channels extending through the interior of the last that are fluidly connected to the second inlet port, and flowing the second material from each second channel, out a respective second outlet port of the second channel that is disposed on the outer surface of the last, and directly onto the outer surface of the last.

9. The method of claim 8, wherein first outlet ports of the plurality of interconnected first channels are spaced away from second outlet ports of the plurality of interconnected second channels on the outer surface of the last.

10. A last for forming an article of footwear, comprising:
a plurality of interconnected channels extending through an interior of the last, wherein the plurality of interconnected channels comprises:
a main channel;
a plurality of branched channels; and
a plurality of outlet ports spaced apart across an outer surface of the last, wherein each branched channel of the plurality of branched channels extends from a different location on the main channel to a respective outlet port of the plurality of outlet ports.

11. The last of claim 10, wherein the plurality of outlet ports are spaced apart across the outer surface of the last such that at least a portion of outlet ports of the plurality of outlet ports are disposed at each of a forefoot region, midfoot region, and heel region of the last.

12. The last of claim 10, wherein the main channel extends from an inlet port on a top portion of the last, through the interior of the last, toward a toe region of the last.

13. The last of claim 10, wherein the plurality of outlet ports are spaced apart across the outer surface of the last such that the plurality of outlet ports extend around an ankle region of the last, and further comprising a plurality of surface features extending from the ankle region toward a ground-facing surface of the last, wherein the plurality of surface features are configured to direct a flow of material emitted from the plurality of outlet ports across the outer surface of the last in a specified pattern.

14. The last of claim 10, further comprising a pump fluidly coupled to the main channel, wherein the pump is configured to pump material into and through the main channel and the plurality of branched channels such that the material is emitted directly onto and across the outer surface of the last.

15. The last of claim 10, further comprising a vibration motor coupled to a surface of the last, wherein the vibration motor is configured to emit vibrations at a specified frequency such that patterns of material emitted from the plurality of outlet ports are created on the outer surface of the last.

16. The last of claim 10, further comprising one or more repulsive features disposed on the outer surface of the last, wherein the one or more repulsive features are configured to repel material emitted from the outlet ports onto the outer surface such that none of the material coalesces and solidifies on the one or more repulsive features.

17. The last of claim 16, wherein the one or more repulsive features comprise a nonstick material deposited onto the outer surface of the last.

18. The last of claim 16, wherein the one or more repulsive features are structural features that are directly coupled to or integrated with the outer surface of last and comprise a material that is nonstick or repulsive to the material emitted from the outlet ports.

19. A method of forming an upper of an article of footwear, comprising:
flowing a first material into a first inlet port of a last and through a plurality of interconnected first channels extending through an interior of the last to first outlet ports that are spaced apart from one another on an outer surface of the last, and flowing the first material from the first outlet ports directly onto a first portion of the outer surface of the last;
flowing a second material into a second inlet port of the last and through a plurality of interconnected second channels extending through the interior of the last to second outlet ports that are spaced apart from one another on the outer surface of the last, and flowing the second material from the second outlet ports directly onto a second portion of the outer surface of the last; and
solidifying the first and second materials on the outer surface of the last to form at least a portion of the article of footwear.

20. The method of claim 19, wherein the at least the portion of the article of footwear includes an entire upper of the article of footwear which comprises the first and second materials.
